(19) United States
(12) Patent Application Publication
(10) Pub. No.: US 2024/0117274 A1
(43) Pub. Date: Apr. 11, 2024

(54) SCRUB-FREE CLEANING COMPOSITION

(71) Applicants: BASF SE, Ludwigshafen am Rhein (DE); ECOLAB USA INC., Saint Paul, MN (US)

(72) Inventors: James S. DAILEY, Wyandotte, MI (US); Thomas B. GESSNER, Ypsilanti, MI (US); Mitchell JAMIESON, Wyandotte, MI (US); Jeremy FINISON, Greensboro, NC (US)

(21) Appl. No.: 18/253,454

(22) PCT Filed: Nov. 26, 2021
(86) PCT No.: PCT/EP2021/083140

§ 371 Date: May 18, 2023

Related U.S. Application Data
(60) Provisional application No. 63/121,277, filed on Dec. 4, 2020.

(51) Int. Cl. C11D 1/83; C11D 1/12; C11D 1/722; C11D 1/825; C11D 17/04

(52) U.S. Cl. CPC C11D 1/83; C11D 1/123; C11D 1/722; C11D 1/825; C11D 17/042; C11D 2111/14

(57) ABSTRACT

Disclosed herein is a method for scrub-free cleaning of a soiled solid surface. Additionally disclosed herein is a method of using a cleaning composition for scrub-free cleaning of a soiled solid surface. Further disclosed herein is a unit dose article including the cleaning composition.

### FIELD OF INVENTION

The present invention relates to a method for scrub-free cleaning of a soiled solid surface. The present invention further relates to a use of the cleaning composition for scrub-free cleaning of a soiled solid surface. The present invention also relates to a unit dose article comprising the cleaning composition.

### BACKGROUND OF THE INVENTION

In the institutional, industrial and hospitality industries, cleaning of hard surfaces such as metal, painted metal, glass and tile is a labor intensive activity. Such surfaces commonly appear in kitchens, bathrooms, food preparation and manufacturing locations and food service restaurants. Commonly, in cleaning such surfaces the maintenance personnel apply an aqueous cleaner composition to the surface either in a foamed or non-foamed aqueous composition. Soil is then mechanically contacted with scrub brushes, cleaning towels and other cleaning implements. The soil and the cleaning material are rinsed, and the remaining rinse water is often removed by wiping, squeegee, or other processes. Hard surfaces such as floors requiring cleaning on a daily basis, the investment in labour, energy and cost is significant. Any reduction in the time, energy and materials used in hard surface maintenance will substantially improve productivity and reduce costs. One important step in hard surface maintenance is the scrubbing process during cleaning such surfaces. Also, the solutions available in the market either involve acidic or alkaline cleaners, the handling of which requires personal protective equipment (PPE).

U.S. Pat. No. 4,749,508 discloses acidic floor cleaning composition comprising acids such as citric acid, sulfamic acid, phosphoric acid, a buffering agent and a nonionic and/or anionic surfactant.

U.S. Pat. No. 5,902,411 discloses a method for treating and maintaining a floor comprising applying an aqueous solution of a surfactant and a fluoride containing compound (treating agent) on the floor, spreading the aqueous solution over the floor and removing said solution from the floor.

In all the prior art references mentioned above, the cleaning compositions require abrasive scrubbing with a scrubber/brush as part of the cleaning process and also necessitate wearing of PPE, in order to avoid exposure.

Thus, it was an object of the present invention to provide a method for cleaning a hard surface with minimum cleaning steps, i.e. which does not require scrubbing and doesn't pose a health hazard.

### SUMMARY OF THE INVENTION

Surprisingly, it has been found that a method for cleaning a hard surface by a cleaning composition obtained by combining certain surfactants provides efficient removal of soil without any requisite of scrubbing the surface or any health hazard.

Accordingly, in one aspect, the present invention is directed to a method for scrub-free cleaning of a soiled solid surface comprising the step of
(A) applying onto said surface a cleaning composition comprising
   (i) at least two surfactants selected from
      (a) a nonionic surfactant of formula (I)

R₁—O-(A)ₓ-(B)_{y1}-(A)_{z}-(B)_{y2}—R₂ (I),
wherein
R₁ is selected from linear or branched, substituted or unsubstituted C₁-C₂₂ alkyl,
R₂ is selected from H and linear or branched, substituted or unsubstituted C₁-C₂₂ alkyl,
A is CH₂—CH₂—O,
B is CH₂—CHR₃—O, wherein R₃ is selected from H and linear or branched, unsubstituted C₁-C₁₀ alkyl,
x is an integer in the range from 0 to 35,
y₁ is an integer in the range from 0 to 60,
y₂ is an integer in the range from 0 to 35,
z is an integer in the range from 0 to 35, and
wherein the sum of x+y₁+z+y₂ is at least 1;
(b) an alkylpolyglycoside of general formula (II)

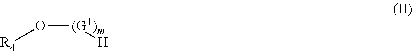

wherein
R₄ is a linear or branched, substituted or unsubstituted C₆ to C₃₀ alkyl,
G¹ is a monosaccharide residue having 5 or 6 carbon atoms,
m is on average in the range of 1 to 10;
(c) an anionic surfactant of general formula (III)

R₅—O-(D)ₚ-(E)_{q}-SO₃-M (III)
wherein
R₅ is a linear or branched, unsubstituted C₆-C₂₂ alkyl,
D denotes CH(CH₃)—CH₂—O—,
E denotes CH₂—CH₂—O—
p is an integer in the range from 0 to 10,
q is an integer in the range from 0 to 5,
M is H or an alkali metal or ammonium cation; and
(d) a sulfosuccinate ester of general formula (IV)

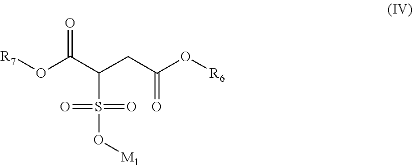

wherein
R₆ is a linear or branched, substituted or unsubstituted C₄ to C₂₂ alkyl,
R₇ is selected from H or a linear or branched, substituted or unsubstituted C₄ to C₂₂ alkyl, and
M₁ is H or an alkali metal cation.

In another aspect, the present invention is directed to a use of the cleaning composition as described herein above, for scrub-free cleaning of a soiled solid surface.

In another aspect, the present invention is directed to a unit dose article comprising the cleaning composition as described herein above.

‘Scrub-free’ herein refers to cleaning without rubbing the soiled solid surface using any abrasive material, scrub pads, brushes or scrubbing machines. Mopping is not a scrubbing procedure.

‘Soiled surface’ herein refers to oil spills, airborne grease deposit on kitchen surfaces such as floors, in commercial kitchens and restaurants. During cooking, animal or vegetable fats become air borne and deposit on surfaces including floors. When the fat contacts the air, it polymerizes and forms an invisible layer of soil on surfaces including floors.

‘Solid surface’ or ‘hard surface’ herein refers to the surfaces which are solid under standard conditions, such as flooring ceramic, clay, stone.

‘Flooring’ herein refers to but not limited to, inorganic materials, e.g., ceramic tile and natural stone, concrete with quarry tile being of particular importance. Also, whereas flooring in restaurants, especially food service restaurants, is of particular pertinence in this invention, other environments include, but are not limited to, food processing and/or preparation establishments, slaughter houses, packing plants, shortening production plants, any and all kitchen areas, etc.

A concentrate refers to the cleaning composition that is diluted to form a use solution before it is applied to a soiled solid surface.

A use solution refers to the cleaning composition that is applied to a soiled solid surface.

### DETAILED DESCRIPTION OF THE INVENTION

Before the present compositions, concentrates and formulations of the invention are described, it is to be understood that this invention is not limited to particular compositions, concentrates and formulations described, since such compositions, concentrates and formulation may, of course, vary. It is also to be understood that the terminology used herein is not intended to be limiting, since the scope of the present invention will be limited only by the appended claims.

If hereinafter a group is defined to comprise at least a certain number of embodiments, this is meant to also encompass a group which preferably consists of these embodiments only. Furthermore, the terms “first”, “second”, “third” or “(a)”, “(b)”, “(c)”, “(d)” etc. and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein. In case the terms “first”, “second”, “third” or “(A)”, “(B)” and “(C)” or “(a)”, “(b)”, “(c)”, “(d)”, “i”, “ii” etc. relate to steps of a method or use or assay there is no time or time interval coherence between the steps, that is, the steps may be carried out simultaneously or there may be time intervals of seconds, minutes, hours, days, weeks, months or even years between such steps, unless otherwise indicated in the application as set forth herein above or below.

In the following passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment but may do so. Furthermore, the particular features, structures or characteristics may be combined in any suitable manner, as would be apparent to a person skilled in the art from this disclosure, in one or more embodiments. Furthermore, while some embodiments described herein include some, but not other features included in other embodiments, combinations of features of different embodiments are meant to be within the scope of the invention, and form different embodiments, as would be understood by those in the art. For example, in the appended claims, any of the claimed embodiments can be used in any combination.

Further, it shall be noted that the terms “at least one”, “one or more” or similar expressions indicating that a feature or element may be present once or more than once typically will be used only once when introducing the respective feature or element. In the following, in most cases, when referring to the respective feature or element, the expressions “at least one” or “one or more” will not be repeated, non-withstanding the fact that the respective feature or element may be present once or more than once.

Furthermore, the ranges defined throughout the specification include the end values as well, i.e. a range of 1 to 10, between 1 to 10 imply that both 1 and 10 are included in the range. For the avoidance of doubt, the applicant shall be entitled to any equivalents according to applicable law.

An aspect of the present invention is directed to a method for scrub-free cleaning of a soiled solid surface comprising the step of:
(A) applying onto said surface a cleaning composition comprising
   (i) at least two surfactants selected from
      (a) a nonionic surfactant of formula (I)

R₁—O-(A)ₓ-(B)_{y1}-(A)_{z}-(B)_{y2}—R₂ (I),
wherein
R₁ is selected from linear or branched, substituted or unsubstituted C₁-C₂₂ alkyl,
R₂ is selected from H and linear or branched, substituted or unsubstituted C₁-C₂₂ alkyl,
A is CH₂—CH₂—O,
B is CH₂—CHR₃—O, wherein R₃ is selected from H and linear or branched, unsubstituted C₁-C₁₀ alkyl,
x is an integer in the range from 0 to 35,
y₁ is an integer in the range from 0 to 60,
y₂ is an integer in the range from 0 to 35,
z is an integer in the range from 0 to 35, and
wherein the sum of x+y₁+z+y₂ is at least 1;
(b) an alkylpolyglycoside of general formula (II)

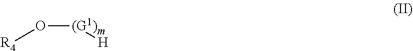

wherein
R₄ is a linear or branched, substituted or unsubstituted C₆ to C₃₀ alkyl,
G¹ is a monosaccharide residue having 5 or 6 carbon atoms,
m is on average in the range of 1 to 10;
(c) an anionic surfactant of general formula (III)

R₅—O-(D)ₚ-(E)_{q}-SO₃-M (III)
wherein
D denotes CH(CH₃)—CH₂—O—,
E denotes CH₂—CH₂—O—
p is an integer in the range from 0 to 10,
q is an integer in the range from 0 to 5,
M is H or an alkali metal or ammonium cation; and
(d) a sulfosuccinate ester of general formula (IV)

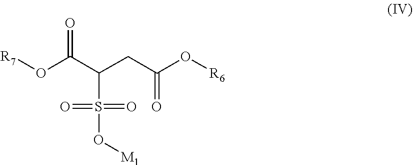

wherein
R₆ is a linear or branched, substituted or unsubstituted C₄ to C₂₂ alkyl,
R₇ is selected from H or a linear or branched, substituted or unsubstituted C₄ to C₂₂ alkyl, and
M₁ is H or an alkali metal cation.

Nonionic Surfactant of General Formula (I)

The nonionic surfactant of general formula (I) has the following structure

R₁—O-(A)ₓ-(B)_{y1}-(A)_{z}-(B)_{y2}—R₂ (I),
wherein
R₁ is selected from linear or branched, substituted or unsubstituted C₁-C₂₂ alkyl,
R₂ is selected from H and linear or branched, substituted or unsubstituted C₁-C₂₂ alkyl,
A is CH₂—CH₂—O,
B is CH₂—CHR₃—O, wherein R₃ is selected from H and linear or branched, unsubstituted C₁-C₁₀ alkyl,
x is an integer in the range from 0 to 35,
y₁ is an integer in the range from 0 to 60,
y₂ is an integer in the range from 0 to 35,
z is an integer in the range from 0 to 35, and
wherein the sum of x+y₁+z+y₂ is at least 1;

Preferably the sum of x+y₁+z+y₂ is in the range of 1 to 50, more preferably the sum of x+y₁+z+y₂ is in the range of 1 to 40 even more preferably the sum of x+y₁+z+y₂ is in the range of 2 to 30 and most preferably the sum of x+y1+z+y2 is in the range of 2 to 25.

Within the context of the present invention, the term “alkyl”, as used herein, refers to acyclic saturated aliphatic residues, including linear or branched alkyl residues. Furthermore, the alkyl residue is preferably unsubstituted and includes as in the case of C₁-C₂₂ alkyl 1 to 22 carbon atoms.

As used herein, “branched” denotes a chain of atoms with one or more side chains attached to it. Branching occurs by the replacement of a substituent, e.g., a hydrogen atom, with a covalently bonded aliphatic moiety.

Representative examples of linear and branched, unsubstituted C₁-C₂₂ alkyl include, but are not limited to methyl, ethyl, n-propyl, n-butyl, n-pentyl, n-hexyl, n-heptyl, n-octyl, n-nonyl, n-decyl, n-undecyl, n-dodecyl, n-tridecyl, n-tetradecyl, n-pentadecyl, n-hexadecyl, n-heptadecyl, n-octadecyl, n-nonadecyl, n-eicosyl, n-heneicosyl, n-docosyl, isopropyl, isobutyl, isopentyl, isohexyl, isoheptyl, isooctyl, isononyl, isodecyl, isoundecyl, isododecyl, isotridecyl, isotetradecyl, isopentadecyl, isohexadecyl, isoheptadecyl, isooctadecyl, isononadecyl, isoeicosyl, isoheneicosyl, isodocosyl, 2-propyl heptyl, 2-ethyl hexyl and t-butyl.

In an embodiment, R₁ is a branched, unsubstituted C₆-C₁₈ alkyl, x is an integer in the range of 2 to 15, y₁ is an integer in the range of 2 to 15, y₂ is 0, z is 0, R₂ is H, R₃ is methyl and wherein the sum of x+y₁+z+y₂ is at least 4.

In an embodiment, R₁ is a branched, unsubstituted C₆-C₁₈ alkyl, x is an integer in the range of 1 to 15, y₁ is 0, y₂ is 0, z is 0, R₂ is H, and wherein the sum of x+y₁+z+y₂ is at least 1.

In an embodiment, R₁ is a linear or branched, unsubstituted C₆-C₁₈ alkyl, x is an integer in the range of 1 to 15, y₁ is an integer in the range of 1 to 15, y₂ is 0, z is 0, R₂ is H, R₃ is methyl and wherein the sum of x+y₁+z+y₂ is at least 1.

In an embodiment, R₁ is a linear or branched, unsubstituted C₈-C₂₂ alkyl, x is an integer in the range of 0.1 to 10, y₁ is an integer in the range of 1 to 10, y₂ is 0, z is 0, R₂ is H, R₃ is methyl and wherein the sum of x+y₁+z+y₂ is at least 1.

In an embodiment, R₁ is linear or branched, unsubstituted C₁-C₂₂ alkyl, x is an integer in the range of 1 to 30, y₁ is an integer in the range of 0 to 30, y₂ is 0, z is 0, R₂ is H and wherein the sum of x+y₁+z+y₂ is at least 1.

In a preferred embodiment, R₁ is branched, unsubstituted C₈-C₁₆ alkyl, x is an integer in the range of 2 to 15, y₁ is an integer in the range of 0 to 10, y₂ is 0, z is 0, R₂ is H or methyl and wherein the sum of x+y₁+z+y₂ is at least 1.

In another preferred embodiment, R₁ is branched, unsubstituted C₈-C₁₄ alkyl, x is an integer in the range of 2 to 10, y₁ is 0, y₂ is 0, z is 0, R₂ is H and wherein the sum of x+y₁+z+y₂ is at least 2.

In another preferred embodiment, R₁ is branched, unsubstituted C₈-C₁₄ alkyl, x is 0, y₁ is an integer in the range of 4 to 10, y₂ is 0, z is an integer in the range of 3 to 10, R₂ is H, R₃ is methyl and wherein the sum of x+y₁+z+y₂ is at least 3.

Suitable nonionic surfactant of the general formula (I) are as listed in Table-1

TABLE 1

| | R₁ | x | y₁ | z | y₂ | R₂ | R₃ |
|---|---|---|---|---|---|---|---|
| Surfactant 1 | C₁₃ branched, | 9 | 0 | 0 | 0 | H | — |
| | unsubstituted | | | | | | |
| Surfactant 2 | C₁₃ branched, | 3 | 0 | 0 | 0 | H | — |
| | unsubstituted | | | | | | |
| Surfactant 3 | C₁₀ branched, | 5 | 1.9 | 0 | 0 | H | — |
| | unsubstituted | | | | | | |
| Surfactant 4 | C₁₀ branched, | 0 | 8 | 7 | 0 | H | methyl |
| | unsubstituted | | | | | | |

Alkylpolyglycoside of General Formula (II)

Alkylpolyglycosides of general formula (II) have the following structure

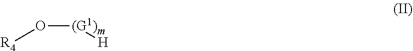

wherein
R₄ is a linear or branched, substituted or unsubstituted C₆ to C₃₀ alkyl,
G¹ is a monosaccharide residue having 5 or 6 carbon atoms,
m is on average in the range of 1 to 10;

As used herein, the term “branched alkyl” is a radical of a saturated branched aliphatic group having an average number of branching of at least 0.7 as defined below. Preferably, the term “branched alkyl” refers to a radical of a saturated branched aliphatic group having an average number of branching of ranging from 0.9 to 3.5, more preferably ranging from 1.8 to 3.5 and most preferably from 2.0 to 2.5 as defined below. It is appreciated that the number of carbon atoms includes carbon atoms along the chain backbone as well as branching carbons.

As used herein, ‘average number of branches per molecule chain’ refers to the average number of branches per alcohol molecule which corresponds to the corresponding branched alkyl, as measured by ¹³C Nuclear Magnetic Resonance (¹³C NMR). The average number of carbon atoms in the chain are determined by gas chromatography.

Various references will be made throughout this specification and the claims to the percentage of branching at a given carbon position, the percentage of branching based on types of branches, average number of branches, and percentage of quaternary atoms. These amounts are to be measured and determined by using a combination of the following three ¹³C-NMR techniques.
(1) The first is the standard inverse gated technique using a 45-degree tip ¹³C pulse and 10 s recycle delay (an organic free radical relaxation agent is added to the solution of the branched alcohol in deuterated chloroform to ensure quantitative results). (2) The second is a J-Modulated Spin Echo NMR technique (JMSE) using a 1/J delay of 8 ms (J is the 125 Hz coupling constant between carbon and proton for these aliphatic alcohols). This sequence distinguishes carbons with an odd number of protons from those bearing an even number of protons, i.e. CH₃/CH vs CH₂/Cq (Cq refers to a quaternary carbon) (3) The third is the JMSE NMR “quat-only” technique using a % J delay of 4 ms which yields a spectrum that contains signals from quaternary carbons only. The JSME NMR quat only technique for detecting quaternary carbon atoms is sensitive enough to detect the presence of as little at 0.3 atom % of quaternary carbon atoms. As an optional further step, if one desires to confirm a conclusion reached from the results of a quat only JSME NMR spectrum, one may also run a DEPT-135 NMR sequence. The DEPT-135 NMR sequence may be very helpful in differentiating true quaternary carbons from breakthrough protonated carbons. This is due to the fact that the DEPT-135 sequence produces the “opposite” spectrum to that of the JMSE “quat-only” experiment. Whereas the latter nulls all signals except for quaternary carbons, the DEPT-135 nulls exclusively quaternary carbons. The combination of the two spectra is therefore very useful in spotting non quaternary carbons in the JMSE “quat only” spectrum. When referring to the presence or absence of quaternary carbon atoms throughout this specification, however, it is meant that the given amount or absence of the quaternary carbon is as measured by the quat only JSME NMR method. If one optionally desires to confirm the results, then also using the DEPT-135 technique to confirm the presence and amount of a quaternary carbon.

For example, the branched C₁₃-alkyl has an average number of branching of from 0.9 to 3.5, more preferably ranging from 1.8 to 3.5 and most preferably from 2.0 to 2.5. The number of branching is defined as the number of methyl groups in one molecule of the corresponding alcohol of the branched alkyl minus 1. The average number of branching is the statistical average of the number of branching of the molecules of a sample.

The branched alkyl can be characterized by the NMR technique as having from 5 to 25% branching on the C₂ carbon position, relative to the ether group. In a preferred embodiment, from 10 to 20% of the number of branches are at the C₂ position, as determined by the NMR technique. The branched alkyl also generally has from 10% to 50% of the number of branches on the C₃ position, more typically from 15% to 30% on the C₃ position, also as determined by the NMR technique. When coupled with the number of branches seen at the C₂ position, the branched alkyl in this case contain significant amount of branching at the C₂ and C₃ carbon positions.

Thus, the branched alkyl of the present invention has a significant number of branches at the C₂ and C₃ positions. Additionally, or alternatively, the branched alkyl preferably has ≥7%, more preferably ≤5%, of isopropyl terminal type of branching, as determined by the NMR technique, meaning methyl branches at the second to last carbon position in the backbone relative to the ether group.

In one embodiment, the branching occurs across the length of the carbon backbone. It is however preferred that at least 20%, more preferably at least 30%, of the branches are concentrated at the C₂, C₃, and isopropyl positions. Alternatively, the total number of methyl branches number is at least 40%, even at least 50%, of the total number of branches, as measured by the NMR technique described above. This percentage includes the overall number of methyl branches seen by the NMR technique described above within the C₁ to the C₃ carbon positions relative to the ether group, and the terminal isopropyl type of methyl branches.

The term “unsubstituted” means that the branched alkyl group is free of substituents, i.e. the branched alkyl group is composed of carbon and hydrogen atoms only.

In one embodiment, the two or more compounds of the composition differ in R₄. Preferably, the composition comprises a mixture of two or more compounds of the general formula (II) differing in R₄, while G¹ and m are the same. If two or more compounds of the composition differ in R₄, R₄ may differ in the number of carbon atoms (i.e. the length) or the kind of branching.

For example, if the two or more compounds of the composition differ in the number of carbon atoms (i.e. the length), one of the two or more compounds is a compound, wherein R₄ is unsubstituted branched C₉-alkyl, and one or more compound(s) of the two or more compounds is a compound, wherein R₄ is unsubstituted branched C₁₀-alkyl, unsubstituted branched C₁₁-alkyl, unsubstituted branched C₁₂-alkyl and/or unsubstituted branched C₁₃-alkyl. Similarly, if the two or more compounds of the composition differ in the number of carbon atoms (i.e. the length), one of the two or more compounds is a compound, wherein R₄ is linear, unsubstituted C₃-C₁₀ alkyl, and one or more compound(s) of the two or more compounds is a compound, wherein R₄ is linear, unsubstituted C₆-alkyl and/or linear, unsubstituted C₁₂-alkyl. Also, if the two or more compounds of the composition differ in the number of carbon atoms (i.e. the length), one of the two or more compounds is a compound, wherein R₄ is linear, unsubstituted C₁₂-C₁₄ alkyl and one or more compound(s) of the two or more compounds is a compound, wherein R₄ is linear, unsubstituted C₈-alkyl and/or linear, unsubstituted C₁₀-alkyl, and/or linear, unsubstituted C₁₆-alkyl linear and/or linear, unsubstituted C₁₈-alkyl.

Alternatively, if the two or more compounds of the composition differ in the kind of branching, it is appreciated that the two or more compounds are compounds having the same number of carbon atoms (i.e. the length), but the branching across the length of the carbon backbone is different. For example, each of the two or more compounds are unsubstituted branched C₁₃-alkyl, wherein R₄ differs in the branching across the length of the carbon backbone. Accordingly, R₄ is a mixture of different unsubstituted branched C₉-C₁₃-alkyl.

If R₄ is a mixture of different unsubstituted branched C₉-C₁₅ alkyl, it is appreciated that it is not excluded that the composition comprises minor amounts of R₄ being unsubstituted straight-chain C₉-C₁₅ alkyl, i.e. C₉-C₁₅ alkyl being free of branches. For example, the composition comprising two or more compounds of the general formula (II), comprises one or more compounds, wherein R₄ is unsubstituted straight-chain C₉-C₁₅ alkyl, in an amount of ≥1.0 wt.-%, based on the total weight of the composition.

Preferably, the two or more compounds of the composition differ in R₄.

The two or more compounds of the general formula (II) are preferably obtained by the corresponding glycosylation of a mixture of alcohols. It is to be noted that the mixture of alcohols is preferably obtained by hydroformylating and optionally hydrogenation of a trimer butene or a tetramer propene, more preferably of a trimer butene. A process for preparing the mixture of alcohols is e.g. described in WO 2001/36356 A2.

In the general formula (II), G¹ is selected from monosaccharides with 5 or 6 carbon atoms. For example, G¹ is selected from pentoses, and hexoses. Examples of pentoses are ribulose, xylulose, ribose, arabinose, xylose and lyxose. Examples of hexoses are galactose, mannose, rhamnose and glucose. Monosaccharides may be synthetic or derived or isolated from natural products, hereinafter in brief referred to as natural saccharides or natural polysaccharides, and natural saccharides natural polysaccharides being preferred. More preferred are the following natural monosaccharides: glucose, xylose, arabinose, rhamnose and mixtures of the foregoing, even more preferred are glucose and/or xylose, and in particular xylose. Monosaccharides can be selected from any of their enantiomers, naturally occurring enantiomers and naturally occurring mixtures of enantiomers being preferred. Naturally, in a specific molecule only whole groups of G¹ can occur.

Thus, if G¹ in the general formula (II) is a pentose, the pentose may be selected from ribulose such as D-ribulose, L-ribulose and mixtures thereof, preferably D-ribulose, xylulose such as D-xylulose, L-xylulose and mixtures thereof, preferably D-xylulose, ribose such as D-ribose, L-ribose and mixtures thereof, preferably D-ribose, arabinose such as D-arabinose, L-arabinose and mixtures thereof, preferably L-arabinose, xylose such as D-xylose, L-xylose and mixtures thereof, preferably D-xylose and lyxose such as D-lyxose, L-lyxose and mixtures thereof, preferably D-lyxose. If G¹ in the general formula (II) is a hexose, the hexose may be selected from galactose such as D-galactose, L-galactose and mixtures thereof, preferably D-galactose, mannose such as D-mannose, L-mannose and mixtures thereof, preferably D-mannose, rhamnose such as D-rhamnose, L-rhamnose and mixtures thereof, preferably L-rhamnose and glucose such as D-glucose, L-glucose and mixtures thereof, preferably D-glucose. More preferably, G¹ in the general formula (II) is glucose, preferably D-glucose, xylose, preferably D-xylose, arabinose, preferably D-arabinose, rhamnose, preferably L-rhamnose, and mixtures of the foregoing, even more preferably G¹ in the general formula (II) is glucose, preferably D-glucose and/or xylose, preferably D-xylose, and/or arabinose, preferably D-arabinose, and in particular xylose, preferably D-xylose and/or arabinose, preferably D-arabinose. For example, G¹ in the general formula (II) is xylose, preferably D-xylose or arabinose, preferably D-arabinose.

In one embodiment, G¹ is selected from monosaccharides with 5 or 6 carbon atoms, which are obtained from a fermentative process of a biomass source. The biomass source may be selected from the group comprising pine wood, beech wood, wheat straw, corn straw, switchgrass, flax, barley husk, oat husk, bagasse, miscanthus and the like.

Thus, it is appreciated that G¹ can comprise a mixture of monosaccharides with 5 or 6 carbon atoms.

In a preferred embodiment, G¹ is glucose. In another preferred embodiment, G¹ is a mixture of monosaccharides with 5 or 6 carbon atoms such as, but are not limited to, a mixture of xylose and glucose or a mixture of xylose and arabinose and optionally glucose. Thus, G¹ is preferably a mixture of xylose and glucose or a mixture of xylose and arabinose and optionally glucose.

If the mixture of monosaccharides with 5 or 6 carbon atoms comprises a mixture of glucose and xylose, the weight ratio of glucose to xylose may vary in a wide range, depending on the biomass source used. For example, if the mixture of monosaccharides with 5 or 6 carbon atoms comprises a mixture of glucose and xylose, the weight ratio of glucose to xylose (glucose [wt.-%]/xylose [wt.-%]) in the mixture is preferably from 20:1 to 1:10, more preferably from 10:1 to 1:5, even more preferably from 5:1 to 1:2 and most preferably from 3:1 to 1:1.

If the mixture of monosaccharides with 5 or 6 carbon atoms comprises a mixture of xylose and arabinose, the weight ratio of xylose to arabinose may vary in a wide range, depending on the biomass source used. For example, if the mixture of monosaccharides with 5 or 6 carbon atoms comprises a mixture of xylose and arabinose, the weight ratio of xylose to arabinose (xylose [wt.-%]/arabinose [wt.-%]) in the mixture is preferably from 150:1 to 1:10, more preferably from 100:1 to 1:5, even more preferably from 90:1 to 1:2 and most preferably from 80:1 to 1:1.

If the mixture of monosaccharides with 5 or 6 carbon atoms comprises a mixture of glucose and xylose and arabinose, the weight ratio of glucose to xylose to arabinose may vary in a wide range, depending on the biomass source used. For example, if the mixture of monosaccharides with 5 or 6 carbon atoms comprises a mixture of glucose and xylose and arabinose, the weight ratio of glucose to arabinose (glucose [wt.-%]/arabinose [wt.-%]) in the mixture is preferably from 220:1 to 1:20, more preferably from 200:1 to 1:15, even more preferably from 190:1 to 1:10 and most preferably from 180:1 to 1:8. Additionally or alternatively, the weight ratio of xylose to arabinose (xylose [wt.-%]/arabinose [wt. %]) in the mixture is preferably from 150:1 to 1:20, more preferably from 120:1 to 1:15, even more preferably from 100:1 to 1:10 and most preferably from 80:1 to 1:8. Additionally or alternatively, the weight ratio of glucose to xylose (glucose [wt.-%]/xylose [wt.-%]) in the mixture is preferably from 150:1 to 1:20, more preferably from 120:1 to 1:15, even more preferably from 100:1 to 1:10 and most preferably from 80:1 to 1:8.

In one embodiment, especially if G¹ is obtained from a fermentative process of a biomass source, G¹ may comprise minor amounts of monosaccharides differing from the monosaccharides with 5 or 6 carbon atoms.

Preferably, G¹ comprises ≥10 wt.-%, more preferably ≤55 wt.-%, based on the total weight of the monosaccharide, of monosaccharides differing from the monosaccharides with 5 or 6 carbon atoms. That is to say, G¹ comprises ≥90 wt.-%, more preferably ≥95 wt.-%, based on the total weight of the monosaccharide, of the monosaccharides with 5 or 6 carbon atoms.

In the general formula (II), m (also named degree of polymerization (DP)) is in the range of from 1 to 10, preferably m is in the range of from 1.05 to 2.5 and most preferably m is in the range of from 1.10 to 1.8, e.g. from 1.1 to 1.4. In the context of the present invention, m refers to average values, and m is not necessarily a whole number. In a specific molecule only whole groups of G¹ can occur. It is preferred to determine m by high temperature gas chromatography (HTGC), e.g. 400° C., in accordance with K. Hill et al., Alkyl Polyglycosides, VCH Weinheim, New York, Basel, Cambridge, Tokyo, 1997, in particular pages 28 ff., or by HPLC. In HPLC methods, m may be determined by the Flory method. If the values obtained by HPLC and HTGC are different, preference is given to the values based on HTGC. In an embodiment, G¹ is selected from glucose, xylose, arabinose, rhamnose, and mixtures thereof.

It is appreciated that two or more compounds of the general formula (II) are provided in the composition. If the composition comprises, preferably consists of, two or more compounds of general formula (II), the two or more compounds present in the composition differ in the groups R₄ and/or G¹ and/or m in the general formula (II). That is to say, the groups R₄ and/or G¹ and/or m can be independently selected from each other.

For example, if the composition comprises, preferably consists of, two or more compounds of general formula (II), R₄ may be independently selected from unsubstituted branched C₉-C₁₅-alkyl, preferably unsubstituted branched C₉-C₁₃-alkyl, more preferably unsubstituted branched C₉- or C₁₀- or C₁₃-alkyl, and most preferably unsubstituted branched C₁₀- or C₁₃-alkyl, while G¹ and m in the general formula (II) are the same for each compound. Alternatively, m may be independently selected from the range of from 1 to 10, preferably from the range of from 1.05 to 2.5 and most preferably from the range of from 1.10 to 1.8, while R₄ and G¹ in the general formula (II) are the same for each compound. Alternatively, G¹ may be independently selected from monosaccharides with 5 or 6 carbon atoms, more preferably from the group consisting of glucose, xylose, arabinose, rhamnose and mixtures thereof and most preferably from glucose and/or xylose, while R₄ and m in the general formula (II) are the same for each compound.

Preferably, the two or more compounds of the general formula (II) differ in R₄. More preferably, the two or more compounds of the general formula (II) differ in R₄, while G¹ and m are the same. It is appreciated that the compounds of the general formula (II) can be present in the alpha and/or beta conformation. For example, the compound of general formula (II) is in the alpha or beta conformation, preferably alpha conformation. Alternatively, the compound of general formula (II) is in the alpha and beta conformation.

If the compound of general formula (II) is in the alpha and beta conformation, the compound of general formula (II) comprise the alpha and beta conformation preferably in a ratio (a/13) from 10:1 to 1:10, more preferably from 10:1 to 1:5, even more preferably from 10:1 to 1:4 and most preferably from 10:1 to 1:3, e.g. about 2:1 to 1:2. In an embodiment, m is in the range of 1.05 to 2.5.

In an embodiment, R₄ is a linear or branched, unsubstituted C₆ to C₂₀ alkyl or branched, unsubstituted C₉ to C₁₅ alkyl.

In a preferred embodiment, R₄ is a linear, unsubstituted C₈ to C₁₆ alkyl or branched, unsubstituted C₉ to C₁₃ alkyl.

In a more preferred embodiment, R₄ is a linear, unsubstituted C₈ to C₁₄ alkyl or a branched, unsubstituted C₉ or C₁₀ or C₁₃ alkyl.

In a most preferred embodiment, R₄ is a linear, unsubstituted C₈ to C₁₀ alkyl or linear, unsubstituted C₁₂-C₁₄ alkyl or a branched, unsubstituted C₁₀ or C₁₃ alkyl.

In a most preferred embodiment, m is in the range of 1.10 to 1.8.

Suitable alkylpolyglycoside of general formula (II) are as listed in Table 2

TABLE 2

| | R₄ | G¹ | m |
|---|---|---|---|
| Surfactant 5 | C₈-C₁₀ linear, unsubstituted | Glucose | 1.5 |
| Surfactant 6 | C₁₃ branched, unsubstituted | Mixture of glucose and | 1.5 |
| | | xylose | |
| Surfactant 7 | C₁₂-C₁₄ linear, unsubstituted | Glucose | 1.5 |
| Surfactant 8 | C₁₀ branched, unsubstituted | Mixture of glucose and | 1.5 |
| | | xylose | |

Anionic Surfactant of General Formula (III)

In an embodiment an anionic surfactant of general formula (III) has the following structure

R₅—O-(D)ₚ-(E)_{q}-SO₃⁻-M (III)
wherein
R₅ is a linear or branched, unsubstituted C₆-C₂₂ alkyl,
D denotes CH(CH₃)—CH₂—O—,
E denotes CH₂—CH₂—O—
p is an integer in the range from 0 to 10,
q is an integer in the range from 0 to 5,
M is H or an alkali metal or ammonium cation;

In a preferred embodiment, R₅ is linear or branched, unsubstituted C₆-C₂₀ alkyl.

In a more embodiment, R₅ is linear or branched, unsubstituted C₃-C₂₀ alkyl.

In a most preferred embodiment, R₅ is linear, unsubstituted C₈-C₁₈ alkyl.

In a preferred embodiment, the cation M is selected from H, sodium, potassium and ammonium cation.

In a preferred embodiment, p=0, q=0, R₅ is linear or branched, unsubstituted C₃-C₁₂ alkyl, M=sodium.

The compounds of the preferred embodiment, p=0, q=0, R₅ is linear or branched, unsubstituted C₈-C₁₂ alkyl, M=sodium, are obtained by sulfating the alcohols (C₈-C₁₂ carbon atoms) produced from the glycerides of tallow, coconut oil, suitable vegetable oil or synthetic alcohols followed by neutralization with alkali hydroxide. Thus, the resulting compounds also contain reaction by-products such as free salt (for example sodium chloride is the free salt by product, when neutralization agent is sodium hydroxide), free fatty alcohol, salt of fatty alcohol. Therefore, the solid content of the compound of general formula (III) may be different from the active content. Active content denotes ‘the amount of compound of general formula (III)’ present in the composition whereas the solid content denotes ‘a total of compound of general formula (III), fatty alcohol, salt of fatty alcohol and the free salt’ in the composition. ‘Free’ herein denotes that the salt is not bound to the fatty alcohol/compound of general formula (III) by any kind of chemical bonding.

In another preferred embodiment, p is an integer in the range of 2 to 10, more preferably in the range of 3 to 8, q is an integer in the range of 0.01 to 10, more preferably in the range of 0.05 to 8, R₅ is linear or branched, unsubstituted C₁₄-C₁₈ alkyl, M=sodium or H.

Compounds of the preferred embodiment where p is an integer in the range of 2 to 10, q is an integer in the range of 0.01 to 10, R₅ is linear or branched, unsubstituted C₁₄-C₁₈ alkyl, M is H are produced by the propoxylation and ethoxylation of fatty alcohol, followed by sulfating the alcohols and thus will generally be obtained in the form of mixtures comprising varying alkyl chain lengths and varying degrees of propoxylation and ethoxylation. Frequently such mixtures may also contain some non-ethoxylated/non-propoxylated compounds. The neutralization of these propoxylated and ethoxylated sulfate compounds with alkali hydroxide such as sodium hydroxide leads to the compounds with M=sodium.

Suitable anionic surfactants of general formula (III) are as listed in Table 3

TABLE 3

| | R₅ | p | q | M |
|---|---|---|---|---|
| Surfactant 8 | C₈ linear, unsubstituted | 0 | 0 | sodium |
| Surfactant 9 | C₁₂ linear, unsubstituted | 0 | 0 | sodium |
| Surfactant 10 | C₁₆-C₁₈ linear, unsubstituted | 7 | 0.1 | sodium |

Sulfosuccinate Ester of General Formula (IV)

Sulfosuccinate ester of general formula (IV) has the following structure

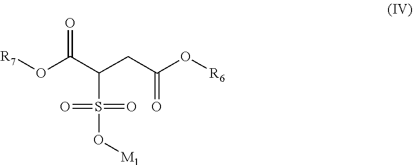

wherein
R₆ is a linear or branched, substituted or unsubstituted C₄ to C₂₂ alkyl,
R₇ is selected from H or a linear or branched, substituted or unsubstituted C₄ to C₂₂ alkyl, and
M₁ is H or an alkali metal cation.

In a preferred embodiment, R₆ and R₇ are independently linear, unsubstituted C₆ to C₂₀ alkyl.

In a more preferred embodiment, R₆ and R₇ are independently linear, unsubstituted C₆ to C₁₆ alkyl.

In a most preferred embodiment, R₆ and R₇ are identical and are linear, unsubstituted C₆ to C₁₂ alkyl.

In a preferred embodiment, the cation M₁ is selected from H, sodium, potassium and ammonium cation.

In a more preferred embodiment, the cation M₁ is selected from sodium and potassium cation.

In a most preferred embodiment, M₁ is sodium.

In a preferred embodiment, the sulfosuccinate ester of general formula (IV) is dissolved in water.

In another preferred embodiment, the sulfosuccinate ester of general formula (IV) is dissolved in a mixture of water and water miscible solvents.

In an embodiment, the water miscible solvents are selected from ethylene glycol, propylene glycol, neopentyl glycol and mixtures thereof.

In a preferred embodiment, the sulfosuccinate ester of general formula (IV) is dissolved in a mixture of water & neopentyl glycol.

Suitable sulfosuccinate ester of general formula (IV) is as listed in Table 4

TABLE 4

| | R₆ | R₇ | M₁ |
|---|---|---|---|
| Surfactant | C₈ linear, unsubstituted | C₈ linear, unsubstituted | sodium |
| 11 | | | |

Additive (A)

In an embodiment, the cleaning composition according to the presently claimed invention further comprises first additive (A). The first additive (A) is selected from a preservative, buffering agent, and mixtures thereof.

Preservative

The preservative is selected from sodium benzoate, potassium sorbate, sodium omadine, phenoxyethanol, parabens, DMDM hydantoin, trichlosan, imidazolidinyl urea, diazolidinyl urea, methylchloroisothiazolinone, methylisothiazolinone, 5-chloro-2-methylisothiazol-3(2H)-one and mixtures thereof.

Buffering Agent

The buffering agent is selected from wherein the buffering agent is selected from citric acid, sodium citrate, potassium citrate, monosodium phosphate, disodium phosphate, trisodium phosphate, sodium tripolyphosphate, tetrasodium pyrophosphate, tetrapotassium pyrophosphate, sodium carbonate, potassium carbonate and sodium sesquicarbonate, potassium sesquicarbonate and mixtures thereof.

Additive (B)

In an embodiment, the cleaning composition according to the presently claimed invention may further comprise a second additive (B). The second additive (B) is different from the first additive (A). The second additive (B) can be, for example selected from chelating agents, fragrances and dyes.

Method

In an embodiment, the method according to the presently claimed invention relates to scrub-free cleaning of a soiled solid surface comprising the step of applying onto said surface a cleaning composition comprising at least two surfactants.

In an embodiment, the soiled solid surface is a flooring.

In another embodiment, the flooring is selected from ceramic tile, polyvinylchloride (PVC) tile, quarry tile, concrete, marble, coral, limestone, granite, porcelain, epoxy, hardwood, laminate and metal.

In another embodiment, the presently claimed invention is directed to the method for scrub-free removal of at least one of oil, grease, or mixtures thereof from the ceramic tile, polyvinylchloride (PVC) tile, quarry tile, concrete, marble, coral, limestone, granite, porcelain, epoxy, hardwood, laminate and metal flooring.

In an embodiment, oil, grease or mixtures thereof are plant or animal based. The term ‘oil’ also includes fat such as Crisco. Plant-based oils include, but are not limited to soybean oil, coconut oil, sesame oil, canola oil, mustard oil, sunflower oil, peanut oil, palm oil olive oil, cottonseed oil or other plant-based oils that is used for cooking purposes. Animal fats include lard, beef tallow, fats from fowl, margarine and butterfat.

In an embodiment, the cleaning composition comprises at least two surfactants, one each selected from non-ionic surfactant of general formula (I), alkylpolyglycoside of general formula (II), an anionic surfactant of general formula (III) or sulfosuccinate ester of general formula (IV).

In another embodiment, the cleaning composition comprises at least three surfactants wherein two surfactants are selected from first non-ionic surfactant of general formula (I) and second non-ionic surfactant of general formula (I) wherein the first non-ionic surfactant of general formula (I) is different than the second non-ionic surfactant of general formula (I), and at least one is selected from alkylpolyglycoside of general formula (II), an anionic surfactant of general formula (III) or sulfosuccinate ester of general formula (IV).

In an embodiment, the cleaning composition comprising of at least two surfactants are a concentrate.

In an embodiment, the total amount of the at least two surfactants are in the range of 45.0% to 90.0% by weight, based on the total weight of the cleaning composition.

In an embodiment, the total amount of the at least two surfactants are in the range of 50.0% to 100.0% by weight, based on the total weight of the cleaning composition.

In an embodiment, the total amount of the at least two surfactants are in the range of 0.01% to 10.0% by weight, based on the total weight of the cleaning composition.

In an embodiment, the total amount of the at least two surfactants are in the range of 11.0% to 20.0% by weight, based on the total weight of the cleaning composition.

In another embodiment, the method may further include a step of first diluting the concentrate into a use solution with water before applying the cleaning composition to a soiled solid surface, and wherein the dilution provides a dispensing rate of a use solution of the cleaning composition in the range of 0.1 floz/gallon (0.75 g/l) to 10 floz/gallon (75 g/I), preferably in the range of 0.2 floz/gallon (1.5 g/I) to 6 floz/gallon (45 g/I), more preferably in the range of 0.3 floz/gallon (2.25 g/I) to 5 floz/gallon (16.9 g/I), still more preferably in the range of 0.4 floz/gallon (3.0 g/I) to 4 floz/gallon (30 g/I) and most preferably in the range of 0.4 floz/gallon (3.0 g/I) to 3 floz/gallon (22.5 g/I).

The cleaning composition comprising the at least two surfactants according to the method of the present invention is stable at all the concentrations which are disclosed above. By ‘stability’ it is meant that the cleaning composition comprising the at least two surfactants does not separate out when stored for a longer time periods of 12 hour to 36 months at room temperature. Room temperature herein denotes a temperature in the range of 20° C. to 35° C.

In an embodiment, the pH of the cleaning composition is about 7. The cleaning composition of the present invention also works well, without the requirement of PPE at pH below 11. The performance of the cleaning composition according to the method of the present invention is improved over both acidic and basic cleaners.

In an embodiment, the method further comprises adding at least one buffering agent to the cleaning composition. The preferred buffering agent is citric acid, sodium citrate and or potassium citrate.

In an embodiment, the surface is soiled with at least one of oil, grease, or mixtures thereof. The oil also forms a film on the soiled solid surface, over time, due to the possible polymerization or crosslinking of the chemical components of oil. In an embodiment, the method of the presently claimed invention cleans the soiled surface of the oil and also removes the film formed over the soiled solid surface, without any scrubbing.

In an embodiment, the efficiency of the method of the presently claimed invention is determined by the measurement of time taken to clean the soil. The time taken to clean the soil is measured using the Recirculating Spray Test. In this test, a soiled tile is treated with a use solution of the cleaning composition comprising the at least two surfactants. The soiled tile is rinsed until the soil is removed. The time it takes for each cleaning composition to completely remove the soil is recorded. The less time it takes to clean the soiled tile, the more efficient is the method. The tile is visually inspected to check if any oil film remained on the tile.

In an embodiment, the cleaning composition is free of hydrotropes. A hydrotrope modifies a formulation to increase the solubility of an insoluble substance or creates micellar or as mixed micellar structures resulting in a stable suspension of the insoluble substance. The cleaning compositions according to the method of the present invention are stable, with no phase separation, and hence do not require the use of hydrotrope.

In an embodiment, the cleaning composition does not require the use of personal protective equipment (PPE) by an end-user.

In an embodiment, the method is rinse free. By rinse free it is meant that the method does not involve rinsing the surface after it is cleaned according to the presently claimed method. Applying the cleaning composition according to the presently claimed invention, on to a soiled solid surface, with any means such as by directly pouring or spraying the use solution on the soiled surface or by means of a mop or a cloth and then wiping it with a cloth or mop renders the surface clean and soil-free. The cleaning compositions in the form of ‘use solution’ can be packaged in a container that comprises a means for creating a spray, e.g., a pump, aerosol propellant or spray valve. This can be thus conveniently applied to the surface to be cleaned by conventional means, such as wiping with a paper towel or cloth, without the need for rinsing. The step of scrubbing the soiled surface to clean it, is not required by the method of the presently claimed invention.

In an embodiment, the cleaning composition as a concentrate can be packed as a unit dose article.

In still another aspect, the presently claimed invention relates to a unit dose article comprising the cleaning composition as described herein above.

In a preferred embodiment, the unit dose article comprises single or multiple compartments.

In another preferred embodiment, the unit dose article is preferably a water-soluble unit dose article. The water-soluble unit dose article may be in the form of a tablet, capsule, sachet, pod or a pouch.

The water-soluble unit dose article comprises at least one internal compartment surrounded by a water-soluble film. The at least one compartment comprises the floor cleaner composition. The water-soluble film is sealed such that the composition does not leak out of the compartment during storage. However, upon addition of the water-soluble unit dose article to water, the water-soluble film dissolves and releases the contents of the internal compartment into the delivery container (i.e. bucket, bottle, watering can, etc). The unit dose article is manufactured such that the water-soluble film completely surrounds the composition and in doing so defines the compartment in which the composition resides. The unit dose article may comprise two films, or even three films. A first film may be shaped to comprise an open compartment into which the composition is added. A second film may then be laid over the first film in such an orientation as to close the opening of the compartment. The first and second films may then be sealed together along a seal region.

The water-soluble unit dose article may comprise two, or even three, or even four internal compartments, preferably wherein the compartments are arranged side-by-side, in a superposed orientation or a mixture thereof. The compartments may be arranged such that two side-by-side compartments are superposed onto a third compartment wherein the third compartment is larger than the first and/or second compartments. Alternatively, the compartments may be arranged such that three side-by-side compartments are superposed onto a fourth compartment, wherein the fourth compartment is larger than the first and/or second and/or third compartments.

The unit dose article may preferably be transparent, translucent or opaque. The water-soluble film may preferably be transparent, translucent or opaque. Preferably, the water-soluble film has a thickness of between 20 microns and 100 microns. Preferably, the film has a water-solubility of at least 50%, preferably at least 75% or even at least 95%.

The film materials are preferably polymeric materials. Preferred polymers, copolymers or derivatives thereof suitable for use as pouch material are selected from the group of polyvinyl alcohols, polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatin, natural gums such as xanthum and carragum. More preferred polymers are selected from the group of polyacrylates and water-soluble acrylate copolymers, methylcellulose, carboxymethylcellulose sodium, dextrin, ethylcellulose, hydroxyethyl cellulose, hydroxypropyl methylcellulose, maltodextrin and polymethacrylates, and most preferably selected from the group of polyvinyl alcohols, polyvinyl alcohol copolymers and hydroxypropyl methyl cellulose (HPMC), and combinations thereof. Preferably, the level of polymer in the pouch material, for example a PVA polymer, is at least 60%.

The polymer can preferably have any weight average molecular weight, more preferably from about 1000 to 1,000,000, even more preferably from about 10,000 to 300,000 and still more preferably from about 20,000 to 150,000 g/mol.

When the unit dose article is added to a container containing water, the water-soluble film dissolves releasing the cleaning composition into the container, thereby resulting in a ‘use solution’ which can then be applied onto the soiled surface, as described above.

In still another aspect, the presently claimed invention relates to a kit comprising a cleaning composition according to the present invention, as defined herein above and instructions for use.

In an aspect, the presently claimed invention is directed to a use of the cleaning composition as defined above, for scrub-free cleaning of a soiled solid surface.

In an embodiment, the soiled solid surface is a flooring.

In another embodiment, the flooring is selected from ceramic tile, polyvinylchloride (PVC) tile, quarry tile, concrete, marble, coral, limestone, granite, porcelain, epoxy, hardwood, laminate and metal.

In another embodiment, the presently claimed invention is directed to the use of the cleaning composition as defined above, for scrub-free removal of at least one of oil, grease, or mixtures thereof from the ceramic tile, polyvinylchloride (PVC) tile, quarry tile, concrete, marble, coral, limestone, granite, porcelain, epoxy, hardwood, laminate and metal flooring.

While the use of the cleaning composition has been described for hard surface such as flooring, it is understood that the composition could be used for other applications. For example, the cleaning compositions can be used to treat other surfaces in restaurants, such as counters and food preparation equipment, that become soiled with the oil or grease or have a film of polymerized oil that build up on solid/hard surfaces. The cleaning compositions can be used to clean equipment, floors, and other solid/hard surfaces in applications such as restaurants and restrooms. The cleaning compositions can be used to clean food and beverage processing plants and food and beverage processing equipment, such as equipment that is used to make cooking fats such as animal and vegetable-based fats and oils and non-trans fats. The cleaning compositions can also be used to clean healthcare facilities such as hospitals, clinics and long-term care facilities

The method of the present invention offers one or more of following advantages:
1. The method is scrub-free.
2. The method is rinse-free method.
3. The method is free of hydrotropes.
4. The method of the present invention beneficially provides stable ready-to-use formulations that are safe for contact without the use of personal protective equipment (PPE).

### Embodiments

The present invention is illustrated in more detail by the following embodiments and combinations of embodiments which result from the corresponding dependency references and links:
1. A method for scrub-free cleaning of a soiled solid surface comprising the step of
   (A) applying onto said surface a cleaning composition comprising
      (i) at least two surfactants selected from
         (a) a nonionic surfactant of general formula (I)

R₁—O-(A)ₓ-(B)_{y1}-(A)_{z}-(B)_{y2}—R₂ (I)
wherein
R₁ is selected from linear or branched, substituted or unsubstituted C₁-C₂₂ alkyl,
R₂ is selected from H and linear or branched, substituted or unsubstituted C₁-C₂₂ alkyl,
A is CH₂—CH₂—O,
B is CH₂—CHR₃—O, wherein R₃ is selected from H and linear or branched, unsubstituted C₁-C₁₀ alkyl,
x is an integer in the range from 0 to 35,
y₁ is an integer in the range from 0 to 60,
y₂ is an integer in the range from 0 to 35,
z is an integer in the range from 0 to 35, and
wherein the sum of x+y₁+z+y₂ is at least 1;
(b) an alkylpolyglycoside of general formula (II)

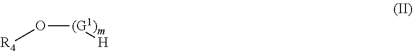

wherein
R₄ is a linear or branched, substituted or unsubstituted C₆ to C₃₀ alkyl,
G¹ is a monosaccharide residue having 5 or 6 carbon atoms,
m is on average in the range of 1 to 10;
(c) an anionic surfactant of general formula (III)

R₅—O-(D)ₚ-(E)_{q}-SO₃-M (III)
wherein
R₅ is a linear or branched, unsubstituted C₆-C₂₂ alkyl,
D denotes CH(CH₃)—CH₂—O—,
E denotes CH₂—CH₂—O—
p is an integer in the range from 0 to 10,
q is an integer in the range from 0 to 5,
M is H or an alkali metal or ammonium cation; and
(d) a sulfosuccinate ester of general formula (IV)

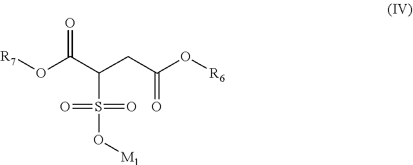

wherein
R₆ is a linear or branched, substituted or unsubstituted C₄ to C₂₂ alkyl,
R₇ is selected from H or a linear or branched, substituted or unsubstituted C₄ to C₂₂ alkyl, and
M₁ is H or an alkali metal cation.
2. The method according to embodiment 1, wherein the cleaning composition further comprises comprising (ii) water.
3. The method according to embodiment 1, wherein R1 is selected from methyl, ethyl, n-propyl, n-butyl, n-pentyl, n-hexyl, n-heptyl, n-octyl, n-nonyl, n-decyl, n-undecyl, n-dodecyl, n-tridecyl, n-tetradecyl, n-pentadecyl, n-hexadecyl, n-heptadecyl, n-octadecyl, n-nonadecyl, n-eicosyl, n-heneicosyl, n-docosyl, isopropyl, isobutyl, isopentyl, isohexyl, isoheptyl, isooctyl, isononyl, isodecyl, isoundecyl, isododecyl, isotridecyl, isotetradecyl, isopentadecyl, iso-hexadecyl, isoheptadecyl, isooctadecyl, isononadecyl, isoeicosyl, isoheneicosyl, isodocosyl, 2-propyl heptyl 2-ethyl hexyl, and t-butyl.
4. The method according to embodiment 1, wherein R1 is a branched, unsubstituted C6-C18 alkyl, x is 0, y1 is an integer in the range of 2 to 15, y2 is an integer in the range of 2 to 15, z is 0, R2 is H, R3 is methyl and wherein the sum of x+y1+z+y2 is at least 4.
5. The method according to embodiment 1, wherein R1 is a branched, unsubstituted C6-C18 alkyl, x is an integer in the range of 1 to 15, y1 is 0, y2 is 0, z is 0, R2 is H, and wherein the sum of x+y1+z+y2 is at least 1.
6. The method according to embodiment 1, wherein R1 is a linear or branched, unsubstituted C6-C18 alkyl, x is an integer in the range of 1 to 15, y1 is an integer in the range of 1 to 15, y2 is 0, z is 0, R2 is H, R3 is methyl and wherein the sum of x+y1+z+y2 is at least 1.
7. The method according to embodiment 1, wherein R1 is a linear or branched, unsubstituted C8-C22 alkyl, x is an integer in the range of 0.1 to 10, y1 is an integer in the range of 1 to 10, y2 is 0, z is 0, R2 is H, R3 is methyl and wherein the sum of x+y1+z+y2 is at least 1.
8. The method according to embodiment 1, wherein R4 is a linear or branched, unsubstituted C6 to C20 alkyl.
9. The method according to embodiment 1, wherein R4 is a linear, unsubstituted C6 to C14 alkyl.
10. The method according to embodiment 1, wherein R4 is a branched, unsubstituted C10 or C13 alkyl.
11. The method according to embodiment 1, wherein G1 is selected from glucose, xylose, arabinose, rhamnose, and mixtures thereof.
12. The method according to embodiment 1, wherein m is in the range of 1.05 to 2.5.
13. The method according to embodiment 1, wherein m is in the range of 1.10 to 1.8.
14. The method according to embodiment 1, wherein R5 is a linear, unsubstituted C8 to C18 alkyl.
15. The method according to embodiment 1, wherein M is selected from H, sodium, and potassium.
16. The method according to embodiment 1, wherein R6 and R7 are identical and are a linear, unsubstituted C6 to C12 alkyl.
17. The method according to embodiment 1, wherein M1 is sodium.
18. The method according to one or more of embodiments 1 to 17, further comprising at least one additive (A) selected from a preservative, buffering agent, and mixtures thereof.
19. The method according to embodiment 18, wherein the preservative is selected from sodium benzoate, potassium sorbate, sodium omadine, phenoxyethanol, parabens, DMDM hydantoin, trichlosan, imidazolidinyl urea, diazolidinyl urea, methylchloroisothiazolinone, methylisothiazolinone and 5-chloro-2-methylisothiazol-3(2H)-one.
20. The method according to embodiment 18, wherein the buffering agent is selected from citric acid, sodium citrate, potassium citrate, monosodium phosphate, disodium phosphate, trisodium phosphate, sodium tripolyphosphate, tetrasodium pyrophosphate, tetrapotassium pyrophosphate, sodium carbonate, potassium carbonate and sodium sesquicarbonate and potassium sesquicarbonate.
21. The method according to one or more of embodiments 1 to 20, wherein the cleaning composition is free of hydrotropes.
22. The method according to one or more of embodiments 1 to 21, wherein the total amount of the at least two surfactants is in the range of 0.01% to 10.0% by weight, based on the total weight of the cleaning composition.
23. The method according to one or more of embodiments 1 to 21, wherein the total amount of the at least two surfactants is in the range of 11.0% to 20.0% by weight, based on the total weight of the cleaning composition.
24. The method according to one or more of embodiments 1 to 21, wherein the total amount of the at least two surfactants is in the range of 45.0% to 90.0% by weight, based on the total weight of the cleaning composition.
25. The method according to one or more of embodiments 1 to 21, wherein the total amount of the at least two surfactants is in the range of 50.0% to 100.0% by weight, based on the total weight of the cleaning composition.
26. The method according to one or more of embodiments 1 to 25, wherein the surface is soiled with at least one of oil, grease, or mixtures thereof.
27. The method according to one or more of embodiments 1 to 26, wherein the cleaning composition does not require the use of personal protective equipment by an end-user.
28. The method according to one or more of embodiments 1 to 27, wherein the method is rinse free.
29. Use of the cleaning composition according to one or more of embodiments 1 to 27 for scrub-free cleaning of a soiled solid surface.
30. The use according to embodiment 29 or the method according to one or more of embodiments 1 to 27 wherein the soiled solid surface is a flooring.
31. The use according to embodiments 29 and 30 or the method according to one or more of embodiments 1 to 27 wherein the flooring is selected from ceramic tile, polyvinylchloride (PVC) tile, quarry tile, concrete, marble, other natural stone, porcelain, epoxy, hardwood, laminate and metal.
32. Use of the cleaning composition according to one or more of embodiments 1 to 27 for scrub-free cleaning of flooring selected from ceramic tile, polyvinylchloride (PVC) tile, quarry tile, concrete, marble, coral, limestone, granite, porcelain, epoxy, hardwood, laminate and metal.
33. The use of the cleaning composition according to one or more of embodiments 1 to 27 for scrub-free removal of at least one of oil, grease, or mixtures thereof from the ceramic tile, polyvinylchloride (PVC) tile, quarry tile, concrete, marble, other natural stone, porcelain, epoxy, hardwood, laminate and metal flooring.
34. A unit dose article comprising the cleaning composition according to one or more of embodiments 1 to 27.
35. The unit dose article according to embodiment 34 having a single compartment or multiple compartments each comprising one of said at least two surfactants.
36. The water-soluble unit dose article according to one or more of embodiments 34 or 3

### Examples

Compounds

Suitable surfactants of the general formula (I), (II), (Ill) and (IV) are as listed in Table-1 to Table-4.

Analytical Methods

Measurement of time taken to clean the soil
The time taken to clean the soil was measured using Recirculating Spray Test. One drop of soil was transferred (0.022±0.002 g) to a previously sealed 2×2 quarry tile. 100 ml cleaning solution was prepared in 150 mL beaker by adding the surfactant blend according to Table-5 and the concentration of surfactants according to Tables 6-8. The flow of cleaning solution being sprayed across each tile was adjusted to 100 mL/min. The cleaning solution was recycled to simulate mop bucket, increasing the soil load over time. The solution was drained into a waste beaker for ˜10 s. Then running tip was placed over the test solution beaker (allowing it to recirculate to saturate lines). The soiled tile was held above the cleaning solution, timer was started, and the soiled tile was rinsed until soil was removed. The time taken for each cleaning composition to completely remove the soil from the tile was recorded. The tile was then visually inspected to check if any oil film remained on the tile.

Surfactant Blends

Table-5: Inventive surfactant blends 1 to 9

TABLE 5

| | Non-ionic | | anionic | sulfosuccinate | | |
|---|---|---|---|---|---|---|
| | surfactant | alkylpolyglycoside | surfactant | ester | | |
| Inventive | of general | of general | of general | of general | | Weight |
| surfactant | formula | formula | formula | formula | Additive | ratio of |
| blend | (I) | (II) | (III) | (IV) | (A) | surfactants |
| 1 | Surfactant 4 | | | Surfactant 11 | | 1:1 |
| 2 | | Surfactant 6 | Surfactant 8 | | | 1:1 |
| 3 | Surfactant 4 + | | | Surfactant 11 | | 1:1:1 |
| | surfactant 1 | | | | | |
| 4 | Surfactant 4 + | | | | | 1:1 |
| | Surfactant 2 | | | | | |
| 5 | Surfactant 3 | | Surfactant 10 | | | 1:1 |
| 6 | Surfactant 4 | | | Surfactant 11 | 0.25% | 1:1:0.05 |
| 7 | Surfactant 4 | | | Surfactant 11 | 0.75% | 1:1:0.15 |
| 8 | Surfactant 4 | | | Surfactant 11 | pH = 9.5 | 1:1 |
| 9 | Surfactant 4 | | | Surfactant 11 | pH = 10.1 | 1:1 |

For a cleaning composition comprising inventive surfactant blends 1 to 9 the mean time to clean measured for soybean/Canola oil-based soil is as in Table-6, examples 1 to 9.

TABLE 6

| | Inventive | Total surfactant | Mean Time | Film |
|---|---|---|---|---|
| | surfactant blend | amount (ppm) | to Clean [s] | Remaining |
| Ex. 1 | 1 | 500 | 36 | No |
| Ex. 2 | 2 | 500 | 28.6 | No |
| Ex. 3 | 3 | 500 | 47 | No |
| Ex. 4 | 4 | 500 | 74.5 | No |
| Ex. 5 | 5 | 500 | 49 | No |
| Ex. 6 | 6 | 500 | 35 | No |
| Ex. 7 | 7 | 500 | 39 | No |
| Ex. 8 | 8 | 500 | 41 | No |
| Ex. 9 | 9 | 500 | 47.5 | No |

For a cleaning composition comprising inventive surfactant blend 1, the mean time to clean (seconds) measured for different concentrations of soils based on Canola oil, Crisco, Soybean oil and a combination of Soybean oil and Canola oil is presented in Table-7, examples 10 to 21.

TABLE 7

| | | Total surfactant | Mean Time to | Film |
|---|---|---|---|---|
| | Soil | amount (ppm) | Clean [s] | Remaining |
| Ex. 10 | Canola oil | 1000 | 34 | No |
| Ex. 11 | | 2500 | 45 | No |
| Ex. 12 | | 3000 | 35 | No |
| Ex. 13 | | 4000 | 46 | No |
| Ex. 14 | Crisco | 2500 | 65 | No |
| Ex. 15 | | 3000 | 48 | No |
| Ex. 16 | | 4000 | 73 | No |
| Ex. 17 | Soybean oil | 1000 | 37 | No |
| Ex. 18 | Soybean oil/ | 1000 | 34 | No |
| Ex. 19 | Canola oil | 2500 | 36 | No |
| Ex. 20 | | 3000 | 25 | No |
| Ex. 21 | | 4000 | 35 | No |

For a cleaning composition comprising inventive surfactant blend 3, following is the mean time to clean measured for different soils based on Canola, Crisco, Soybean and a combination of Soybean and Canola is presented in Table-8, examples 22 to 27.

TABLE 8

| | | Total surfactant | Mean Time to | Film |
|---|---|---|---|---|
| | Soil | amount (ppm) | Clean [s] | Remaining |
| Ex. 22 | Canola oil | 1000 | 76 | No |
| Ex. 23 | | 3000 | 50 | No |
| Ex. 24 | Crisco | 3000 | 110 | No |
| Ex. 25 | | 4000 | 100 | No |
| Ex. 26 | Soybean oil/ | 1000 | 53 | No |
| Ex. 27 | Canola oil | 3000 | 42 | No |

As is evident from Table-6 to Table-8, the method according to the presently claimed invention cleans the soiled tiles in very less time (25 seconds to 110 seconds), with no film remaining on the tiles and without any scrubbing of the tiles.

1. A method for scrub-free cleaning of a soiled solid surface comprising:
(A) applying onto said surface a cleaning composition comprising
(i) at least two surfactants selected from the group consisting of
(a) a nonionic surfactant of general formula (I)
R₁—O-(A)ₓ-(B)_{y1}-(A)_{z}-(B)_{y2}—R₂ (I),
wherein
R₁ is selected from the group consisting of linear or branched and substituted or unsubstituted C₁-C₂₂ alkyl,
R₂ is selected from the group consisting of H and linear or branched and substituted or unsubstituted C₁-C₂₂ alkyl,
A is CH₂—CH₂—O,
B is CH₂—CHR₃—O, wherein R₃ is selected from the group consisting of H and linear or branched, unsubstituted C₁-C₁₀ alkyl,
x is an integer in the range from 0 to 35,
y₁ is an integer in the range from 0 to 60,
y₂ is an integer in the range from 0 to 35,
z is an integer in the range from 0 to 35, and
wherein the sum of x+y₁+z+y₂ is at least 1;
(b) an alkylpolyglycoside of general formula (II) 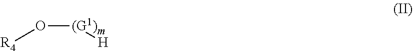
wherein
R₄ is a linear or branched, substituted or unsubstituted C₆ to C₃₀ alkyl,
G¹ is a monosaccharide residue having 5 or 6 carbon atoms,
m is on average in the range of 1 to 10;
(c) an anionic surfactant of general formula (III)
R₅—O-(D)ₚ-(E)_{q}-SO₃-M (III)
wherein
R₅ is a linear or branched, unsubstituted C₆-C₂₂ alkyl,
D denotes CH(CH₃)—CH₂—O—,
E denotes CH₂—CH₂—O—
p is an integer in the range from 0 to 10,
q is an integer in the range from 0 to 5,
M is H or an alkali metal or ammonium cation; and
(d) a sulfosuccinate ester of general formula (IV) 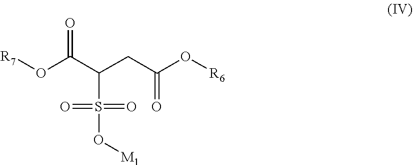
wherein
R₆ is a linear or branched, substituted or unsubstituted C₄ to C₂₂ alkyl,
R₇ is selected from the group consisting of H and a linear or branched, substituted or unsubstituted C₄ to C₂₂ alkyl, and
M₁ is H or an alkali metal cation.

2. The method according to claim 1, wherein the cleaning composition further comprises (ii) water.

3. The method according to claim 1, wherein R₁ is a branched, unsubstituted C₆-C₁₈ alkyl, x is 0, y₁ is an integer in the range of 2 to 15, y₂ is an integer in the range of 2 to 15, z is 0, R₂ is H, R₃ is methyl and wherein the sum of x+y₁+z+y₂ is at least 4.

4. The method according to claim 1, wherein R₁ is a branched, unsubstituted C₆-C₁₈ alkyl, x is an integer in the range of 1 to 15, y₁ is 0, y₂ is 0, z is 0, R₂ is H, and wherein the sum of x+y₁+z+y₂ is at least 1.

5. The method according to claim 1, wherein R₁ is a linear or branched, unsubstituted C₆-C₁₈ alkyl, x is an integer in the range of 1 to 15, y₁ is an integer in the range of 1 to 15, y₂ is 0, z is 0, R₂ is H, R₃ is methyl.

6. The method according to claim 1, wherein R₁ is a linear or branched, unsubstituted C₈-C₂₂ alkyl, x is an integer in the range of 0.1 to 10, y₁ is an integer in the range of 1 to 10, y₂ is 0, z is 0, R₂ is H, R₃ is methyl and wherein the sum of x+y₁+z+y₂ is at least 1.

7. The method according to claim 1, wherein R₄ is a linear, unsubstituted C₆ to C₁₄ alkyl or branched, unsubstituted C₁₀ or C₁₃ alkyl, G¹ is selected from the group consisting of glucose, xylose, arabinose, rhamnose, and mixtures thereof and m is in the range of 1.05 to 2.5.

8. The method according to claim 1, wherein R₅ is a linear, unsubstituted C₆ to C₁₆ alkyl and M is selected from the group consisting of H, sodium, and potassium.

9. The method according to claim 1, wherein R₆ and R₇ are identical and are a linear, unsubstituted C₆ to C₁₂ alkyl and M₁ is sodium.

10. The method according to claim 1, further comprising at least one additive (A) selected from the group consisting of a preservative, buffering agent, and mixtures thereof.

11. The method according to claim 1, wherein the total amount of the at least two surfactants is in the range of 0.01% to 10.0% by weight, based on the total weight of the cleaning composition.

12. The method according to claim 1, wherein the total amount of the at least two surfactants is in the range of 11.0% to 20.0% by weight, based on the total weight of the cleaning composition.

13. The method according to claim 1, wherein the total amount of the at least two surfactants is in the range of 45.0% to 90.0% by weight, based on the total weight of the cleaning composition.

14. The method according to claim 1, wherein the total amount of the at least two surfactants is in the range of 50.0% to 100.0% by weight, based on the total weight of the cleaning composition.

15. A method of using the cleaning composition according to claim 1, the method comprising using the cleaning composition for scrub-free cleaning of a soiled solid surface.

16. The method according to claim 15, wherein the soiled solid surface is a flooring selected from the group consisting of ceramic tile, polyvinylchloride tile, quarry tile, concrete, marble, other natural stone, porcelain, epoxy, hardwood, laminate, and metal.

17. A unit dose article comprising the cleaning composition as defined in claim 1, having a single compartment or multiple compartments each comprising one of said at least two surfactants.

18. The unit dose article according to claim 17, wherein the unit dose article is water-soluble.

19. The method according to claim 1, wherein the soiled solid surface is a flooring selected from the group consisting of ceramic tile, polyvinylchloride tile, quarry tile, concrete, marble, other natural stone, porcelain, epoxy, hardwood, laminate, and metal.
